(19) United States
(12) Patent Application Publication
(10) Pub. No.: US 2025/0328669 A1
(43) Pub. Date: Oct. 23, 2025

(54) TECHNIQUES FOR ACCESSING AND INTERACTING WITH DATA USING DATA ABSTRACTION LAYERS IMPLEMENTED BY A DATA GATEWAY

(71) Applicant: NETFLIX, INC., Los Gatos, CA (US)

(72) Inventors: Shahar ZIMMERMAN, San Francisco, CA (US); Vidyha ARVIND, San Ramon, CA (US); Joseph LYNCH, Gaithersburg, MD (US); Vinay CHELLA, Santa Clara, CA (US)

(21) Appl. No.: 19/070,089

(22) Filed: Mar. 4, 2025

Related U.S. Application Data
(60) Provisional application No. 63/637,297, filed on Apr. 22, 2024.

(51) Int. Cl. G06F 21/62

(52) U.S. Cl. CPC G06F 21/6218

(57) ABSTRACT

One embodiment sets forth a technique for implementing data abstraction layers via a data gateway. According to some embodiments, the technique can include the steps of receiving a request to generate a data abstraction layer instance, where the request includes a set of configuration parameters, identifying, based on the request, a data abstraction layer among a plurality of data abstraction layers implemented by the data gateway, performing at least one operation to generate the data abstraction layer instance based on the data abstraction layer and using the set of configuration parameters, and causing at least one additional request to be routed to the data abstraction layer instance for processing. Another embodiment sets forth a technique for performing data operations using data abstraction layer instances implemented by the data gateway.

### CROSS-REFERENCE TO RELATED APPLICATIONS

The present application claims the benefit of U.S. Provisional Application titled, “TECHNIQUES FOR GENERATING, MODIFYING, AND ACCESSING DATA USING A DATA GATEWAY”, filed on Apr. 22, 2024, and having Ser. No. 63/637,297. The subject matter of this related application is hereby incorporated herein by reference.

### BACKGROUND

### Field of the Various Embodiments

Embodiments of the present disclosure relate generally to computer science and computer networks, and more specifically, to techniques for interacting with data using data abstraction layers implemented by a data gateway.

### Description of the Related Art

Organizations are becoming increasingly reliant on large-scale data operations, which has established the need for tools that can be used to connect to the different datastores utilized by a given organization and access and interact with the data in those different datastores. In many cases, an organization develops internal tools that are tailored to the specific environments and operational needs of that organization. Typically, the internal tools are designed to address particular use cases that are common to the organization and oftentimes leverage custom scripts or implement tightly coupled software components to interact with proprietary or open-source datastore technologies.

Conventional tools for connecting to and interacting with datastores suffer from certain technical drawbacks. One such drawback is the lack of interoperability across different datastores. In particular, as an organization adopts different technologies to meet various operational needs, the internal tools used by the organization can require bespoke configurations—or entirely new implementations—to support additional datastore types. As a result, the internal tools can become fragmented, which can make maintaining compatibility across the different types of datastores difficult. This problem is exacerbated as the number of different datastore types implemented by the organization grows.

Another technical drawback is the difficulty in scaling the functionality and maintaining the security of internal tools over time. Many internal tools are built with rigid architectures that are not easily extensible. As a result, adding new features or updating the internal tools to handle evolving data requirements often requires substantial software development effort. Furthermore, the internal tools may not incorporate robust security measures, such as access control and encryption. As a result, an organization may become vulnerable to data breaches or compliance issues when accessing sensitive data from a particular datastore or transferring sensitive data between datastores.

As the foregoing illustrates, what is needed in the art are more effective techniques for accessing and interacting with data stored across different types of datastores.

### SUMMARY

One embodiment sets forth a computer-implemented method for implementing data abstraction layers via a data gateway. According to some embodiments, the method includes the steps of receiving a request to generate a data abstraction layer instance, where the request includes a set of configuration parameters, identifying, based on the request, a data abstraction layer among a plurality of data abstraction layers implemented by the data gateway, performing at least one operation to generate the data abstraction layer instance based on the data abstraction layer and using the set of configuration parameters, and causing at least one additional request to be routed to the data abstraction layer instance for processing.

Another embodiment sets forth a computer-implemented method for performing data operations using data abstraction layer instances implemented by a data gateway. According to some embodiments, the method can include the steps of receiving, from an endpoint device, a request to perform at least one data operation associated with at least one datastore, identifying, based on the request, a data abstraction layer instance implemented by the data gateway, transmitting the request to the data abstraction layer instance, where the data abstraction layer instance performs the at least one data operation upon receiving the request, receiving at least one response from the data abstraction layer instance based on the at least one data operation, and transmitting the at least one response to the endpoint device.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques enable data operations between different software applications and different datastores to be abstracted, which reduces the need for the software applications to include bespoke code for interacting with different types of datastores. As a result, the disclosed techniques can decrease the fragmentation of tooling ecosystems and simplify the integration of additional datastore types within an organization. Additionally, the ability to modify a given data abstraction layer without having to expose changes to the software applications promotes overall scalability. This adaptability allows an organization to efficiently respond to changing operational needs without having to modify or overhaul existing software application codebases. Additionally, the disclosed techniques enable multiple independent instances of a given data abstraction layer to be implemented, which can promote the isolation and autonomy of data operations across different software applications. This capability enhances fault tolerance as data operations performed by one software application do not interfere with data operations performed by other software applications. Moreover, the data abstraction layers can incorporate security logic for implementing various security measures, such as enhanced access control and encryption, which enhances overall data security when accessing data from a given datastore or transmitting data across different datastores. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a more detailed illustration of the data gateway of FIG. 1, according to various embodiments.

FIG. 3 sets forth a flow diagram of method steps for implementing data abstraction layers via the data gateway of FIG. 1, according to various embodiments.

FIG. 4 sets forth a flow diagram of method steps for performing data operations using data abstraction layer instances implemented by the data gateway of FIG. 1, according to various embodiments.

FIG. 5 is a conceptual illustration of a computing device that can be used to implement any of the computing devices shown in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described, organizations are increasingly relying on large-scale data operations, which is creating a need for internal tools for connecting to and interacting with various datastores. Many organizations develop internal tools tailored to their specific environments, often using custom scripts or tightly coupled software components for interacting with proprietary or open-source datastore technologies. However, these tools face technical challenges, such as a lack of interoperability across different datastores, which requires bespoke configurations or new implementations as additional datastore types are adopted, and can lead to fragmentation and compatibility issues. Moreover, scaling functionality over time can be difficult due to rigid architectures that are not easily extensible, which can require substantial development effort to add features or address evolving data needs. Additionally, inadequate security measures, such as limited access control and encryption, can expose organizations to data breaches or compliance risks when handling sensitive data.

The disclosed techniques set forth a comprehensive system for a data gateway that facilitates interactions between software applications, datastores, and datasets by implementing data abstraction layers. Developers can issue requests to the data gateway to register new data abstraction layers with the data gateway. In turn, a software application executing on an endpoint device can submit a request to the data gateway to generate a data layer abstraction instance of a particular data abstraction layer. The request can include configuration parameters that specify how the data layer abstraction instance should be tailored to meet the operational needs of the software application. In response to the request, the data gateway implements a data abstraction layer engine to function as an execution environment for the data layer abstraction instance. The data gateway then configures the data abstraction layer engine, the data layer abstraction instance, etc., based on the provided configuration parameters so that the data layer abstraction instance is optimized for the intended data operations to be performed by the data layer abstraction instance. When the data abstraction layer instance is active, the software application can issue function calls to the data layer abstraction instance. The function calls can include, for example, at least data read operations, data modification operations, data migration operations, and so on. The function calls can be routed through the data gateway to allow the software application to access specific data operations without needing to directly interact with the underlying datastores and datasets. More specifically, the data abstraction layer instance can adjust operational configurations (e.g., add a cache to lower read latency) as appropriate, while remaining transparent to the application. In this manner, when the operational characteristics of the software application change, a transparent migration to a new optimal storage configuration can automatically occur. The data abstraction layer instance processes the function calls, performs the requested operations on the relevant datastores and datasets, and generates response information reflecting the results of the operations. The response information can then be returned to the software application via the data gateway, thereby enabling seamless communication and integration between the software application, the datastores, and the datasets.

One technical advantage of the disclosed techniques relative to the prior art is that the disclosed techniques enable data operations between different software applications and different datastores to be abstracted, which reduces the need for the software applications to include bespoke code for interacting with different types of datastores. As a result, the disclosed techniques can decrease the fragmentation of tooling ecosystems and simplify the integration of additional datastore types within an organization. Additionally, the ability to modify a given data abstraction layer without having to expose changes to the software applications promotes overall scalability. This adaptability allows an organization to efficiently respond to changing operational needs without having to modify or overhaul existing software application codebases. Additionally, the disclosed techniques enable multiple independent instances of a given data abstraction layer to be implemented, which can promote the isolation and autonomy of data operations across different software applications. This capability enhances fault tolerance as data operations performed by one software application do not interfere with data operations performed by other software applications. Moreover, the data abstraction layers can incorporate security logic for implementing various security measures, such as enhanced access control and encryption, which enhances overall data security when accessing data from a given datastore or transmitting data across different datastores.

### System Overview

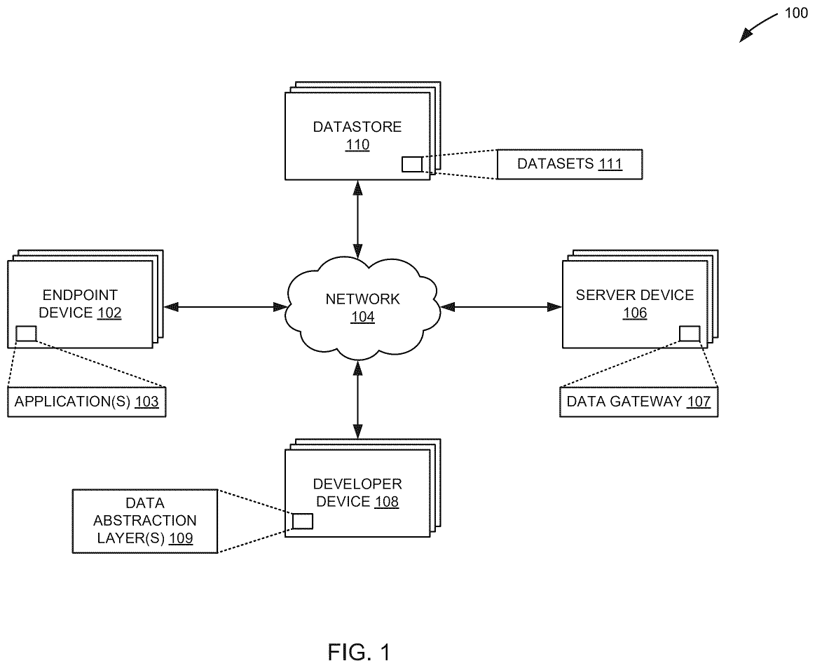

FIG. 1 illustrates a network infrastructure 100 configured to implement one or more aspects of the various embodiments. As shown, the network infrastructure 100 can include at least endpoint device 102, at least one server device 106, at least one developer device 108, and at least one datastore 110, each of which can be connected via a communications network 104. The communications network 104 can represent, for example, any technically feasible network or number of networks, including a wide area network (WAN) such as the Internet, a local area network (LAN), a Wi-Fi network, a cellular network, or a combination thereof.

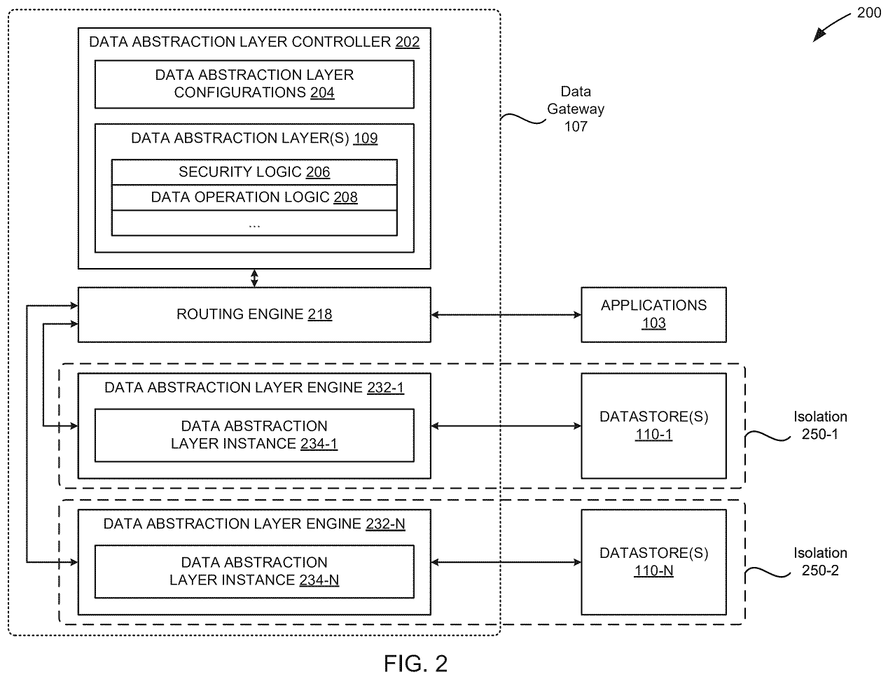

A given server device 106 can represent one or more computing devices, such as rack servers, blade servers, tower servers, microservers, hyper-converged infrastructure servers, mainframe servers, etc., that are implemented by, accessible to, etc., an organization. As shown, the server devices 106 can be configured to implement a data gateway 107 for centralizing and orchestrating the manner in which data operations are carried out within the organization. According to some embodiments, software developers can write, produce, etc., data abstraction layers 109 that are configured to perform specialized data operations on datasets 111 that are implemented by datastores 110. The developers can then provide, e.g., via the developer devices 108, the data abstraction layers 109 to the data gateway 107 for registration. Upon receipt of a data abstraction layer 109, the data gateway 107 can verify that the data abstraction layer 109 satisfies different requirements that are imposed by the data gateway 107. When one or more data connectors have been registered with the data gateway 107, users operating the endpoint devices 102 can interact with the data gateway 107 to access data operations that are available through the data abstraction layers 109. A more detailed explanation of the architecture of the data gateway 107, as well as the functionalities implemented by the data gateway 107, is provided below in conjunction with FIGS. 2-4.

A given datastore 110 can represent any computer, service, entity, etc., that enables datasets 111 to be created, operated on, and accessed. For example, the datastore 110 can represent a distributed database that is optimized for high availability and scalability, a relational database system that is designed for structured data, a search platform capable of indexing and retrieving volumes of data, or the like. The datastore 110 can also represent a stream processing system configured to implement real-time data flows, an object storage service configured to implement scalable data storage and retrieval, or a platform that maintains immutable datasets for consistent access across distributed systems. The datastore 110 can also represent various types of caches, including in-memory caches like those used for high-speed temporary data storage, distributed caches that span multiple nodes for scalability and fault tolerance, and the like. It is noted that the foregoing examples are not meant to be limiting, and that the datastore 110 can represent any number, type, form, etc., of data service(s), and can implement any number, type, form, etc., of dataset(s) 111, at any level of granularity, consistent with the scope of this disclosure.

As shown, the endpoint device 102 can implement one or more software applications 103 that are configured to provide different functionalities. According to some embodiments, a software application 103 can be configured to interface with the data gateway 107 to register, access, etc., data abstraction layers 109 through the data gateway 107. For example, the software application 103 can issue a request to the data gateway 107 to create an instance of a data abstraction layer 109. The request can include configuration information (e.g., in the form of a configuration file) that is compatible with the data abstraction layer 109. In turn, when the data gateway 107 performs operations to generate the instance of the data abstraction layer 109, the software application 103 can communicate with the instance of the data abstraction layer 109 via function calls and associated parameters (e.g., using network protocols such as HTTP, HTTPS, or WebSocket over a transport protocol like TCP or UDP, by incorporating application-layer standards like REST, SOAP, or gRPC for structured data exchange, etc.). A more detailed explanation of the manner in which the software applications 103 can communicate with the data gateway 107 is provided below in conjunction with FIGS. 2-4.

A given developer device 108, as well as a given endpoint device 102, can represent any computing device configured to interact with the server device 106 to access services provided by the data gateway 107. Examples of such computing devices include smartphones, tablets, desktop computers, and laptops. It is noted that the foregoing examples are not meant to be limiting, and that the developer devices 108 and the endpoint devices 102 can represent any number, type, form, etc., of computing device(s), consistent with the scope of this disclosure.

### Data Gateway Architecture

FIG. 2 is a more detailed illustration of the data gateway 107 of FIG. 1, according to various embodiments. As shown, the data gateway 107 can implement a data abstraction layer controller 202, a routing engine 218, and data abstraction layer engines 232. As described herein, and, according to some embodiments, the data abstraction layer controller 202 can be configured to register data abstraction layers 109 within the data abstraction layer controller 202. When the data abstraction layer controller 202 receives (e.g., from a developer device 108) a request to register a data abstraction layer 109 with the data gateway 107, the data abstraction layer controller 202 can implement validation logic to determine whether the data abstraction layer 109 is compatible with the data gateway 107. The validation logic can include, for example, configuration information, executable instructions, etc., for verifying the accuracy, integrity, completeness, etc., of different aspects of the data abstraction layer 109, such as security logic 206 included in the data abstraction layer 109, data operation logic 208 included in the data abstraction layer 109, configuration settings included in the data abstraction layer 109, and so on. It is noted that the foregoing examples are not meant to be limiting, and that the validation logic can be configured to analyze any amount, type, form, etc., of information included in the data abstraction layer 109, at any level of granularity, consistent with the scope of this disclosure.

According to some embodiments, the data abstraction layer 109 can be associated with a unique identifier (not illustrated in FIG. 2) for uniquely identifying the data abstraction layer 109 relative to other data abstraction layers 109 implemented by the data abstraction layer controller 202. The data abstraction layer 109 can also include a unique group identifier for assigning the data abstraction layer 109 to a given group of data abstraction layers 109 (i.e., where all data abstraction layers 109 in the group share the same unique group identifier to effectively assign the data abstraction layers to the group). In this manner, different data abstraction layers 109 can be organized into different groups, which can enable administrators, users, etc., to access the data abstraction layers 109 in a more organized, hierarchical, etc., manner. It should be appreciated that additional unique group identifiers can be assigned to the data abstraction layers 109 so that additional layers of groupings can be effected, consistent with the scope of this disclosure.

According to some embodiments, and, as shown, the data abstraction layer 109 can include security logic 206, which can include authentication framework, credentials, etc., relating to usernames, passwords, application programming interface (API) keys, token-based access configurations, etc., required for software applications 103 to securely access the data abstraction layer 109, at least one of the datastores 110 associated with the data abstraction layer 109, at least one of the datasets 111 associated with the data abstraction layer 109, and the like. In this regard, the security logic 206 can be configured to confirm that credentials are valid, that the credentials can be used to obtain appropriate authorization for requested data operations to be performed, that the credentials conform to any system-wide security protocols (e.g., encryption or token expiration policies), and the like.

As a brief aside, it should be appreciated that other entities described herein can supplement, replace, etc., different aspects of the security logic 206 included in the data abstraction layers 109. For example, the data abstraction layer controller 202 can perform security operations where appropriate. For example, when the data abstraction layer controller 202 receives, from a developer device 108, a request to register a data abstraction layer 109 with the data abstraction layer controller 202, the data abstraction layer controller 202 can verify that the developer device 108, a user associated with the developer device 108, etc., is authorized to issue the request. In another example, when a software application 103 executing on an endpoint device 102 issues a request to generate an instance of a data abstraction layer 109 in the form of a data layer abstraction instance 234, the data abstraction layer controller 202 can verify that endpoint device 102, the software application 103, a user associated with the software application 103, etc., is authorized to issue the request. In yet another example, when a software application 103 executing on an endpoint device 102 issues a request to interact with a given data layer abstraction instance 234, the data layer abstraction instance 234 can verify that the endpoint device 102, the software application 103, a user associated with the software application 103, etc., is authorized to issue the request. It is noted that the foregoing examples are not meant to be limiting, and that any number, type, form, etc., of security check(s) can be performed, at any level of granularity, consistent with the scope of this disclosure.

According to some embodiments, and, as shown, the data abstraction layer 109 can include data operation logic 208. According to some embodiments, the data operation logic 208 can include information that enables the data abstraction layer 109 to programmatically connect to and interact with datastores 110 and datasets 111 implemented by the datastores 110. The information can include connection details such as network addresses, ports, and protocols required to establish communication with the datastores 110. The information can also include metadata that describes structures of the datasets 111 implemented by the datastores 110, such as schema definitions, table names, field names, or data types, which can be used to facilitate the accurate querying and retrieval of data. Additionally, the information can include configuration parameters, such as query preferences, access permissions, timeout settings, etc., so that the data abstraction layer 109 can be fine-tuned to interact with the datastores 110 in a manner that addresses specific operational needs that are serviced by the data abstraction layer 109.

The data operation logic 208 can include information, executable instructions, etc., for performing one or more data operations on one or more datasets 111 implemented by the datastores 110. The data operation logic 208 can include, for example, transformation rules that dictate how the datasets 111 are to be modified, formatted, etc., during the data operations, such as schema mappings for aligning incompatible data structures, data type conversions to ensure consistency between datastores 110 and datasets 111, and normalization processes to standardize the datasets 111 for downstream compatibility. The data operation logic 208 can also include filtering criteria that allow for selective retrieval so that only relevant data is processed. The data operation logic 208 can also include aggregation instructions for combining multiple data elements into unified outputs. The data operation logic 208 can further include enrichment instructions for augmenting datasets 111 with additional attributes.

In additional examples, the data operation logic 208 can define operational workflows that specify the sequence and dependencies of data retrieval, transformation, and delivery tasks to optimize performance and maintain consistency. For instance, the data operation logic 208 can include parallel processing strategies to enhance throughput, conditional logic to dynamically adjust workflows based on dataset 111 properties, runtime conditions, and the like. The data operation logic 208 can also include error-handling protocols that define retry mechanisms for failed data operations, fallback procedures to alternative workflows, and comprehensive logging capabilities to track execution and identify issues for debugging or auditing purposes.

In additional examples, the data operation logic 208 can incorporate security measures to protect sensitive information when performing data operations. Such security measures can include encryption protocols for securing data in transit or at rest, masking or tokenization techniques to obscure sensitive fields, and anonymization rules to comply with privacy regulations. The data operation logic 208 can also include access control configurations to enable data operations to be conducted in accordance with permissions, as well as security policies established for datasets 111, the datastores 110, and so on. In further examples, the data operation logic 208 can be configured to implement conflict resolution rules, metadata to track lineage and changes that take place during data operations, and the like.

It is noted that the foregoing examples are not meant to be limiting, and that data operation logic 208 can include any amount, type, form, etc., of information, at any level of granularity, to effectively enable the data abstraction layer 109 to interact with datastores 110 and datasets 111, consistent with the scope of this disclosure.

As described herein, and, according to some embodiments, a software application 103 executing on an endpoint device 102 can issue, to the data abstraction layer controller 202, a request to generate an instance of a particular data abstraction layer 109 in the form of a data layer abstraction instance 234. In turn, the data abstraction layer controller 202 can perform a series of operations to configure and establish an environment in which the data layer abstraction instance 234 can be configured and executed.

According to some embodiments, the request can include a set of configuration parameters (e.g., included in a configuration file) that corresponds to the data abstraction layer 109. Examples of configuration parameters that can be provided in the request include performance metrics, such as reads per second, writes per second, query latency limits, maximum allowable throughput, and the like. Security settings can also be specified, including data encryption protocols, authentication protocols, role-based access control, and the like. Additionally, resource constraints can be provided, such as maximum memory allocation, CPU core limits, disk I/O bandwidth, storage capacity, and the like. Additionally, operational settings can be provided, such as error handling policies, logging levels, and the like. Timing and scheduling parameters can also be included, such as execution start times, timeout thresholds, retry intervals, and the like. It is noted that the foregoing examples are not meant to be limiting, and that the set of configuration parameters can include any number, type, form, etc., of parameter(s), at any level of granularity, consistent with the scope of this disclosure.

According to some embodiments, the data abstraction layer controller 202 can evaluate the computational resources required to satisfy the set of configuration parameters. According to some embodiments, the data abstraction layer controller 202 can interface with an underlying infrastructure layer, which can include cloud-based services, on-premises servers, hybrid systems, etc., to allocate the appropriate resources for implementing the data layer abstraction instance 234. For instance, if the request indicates a high throughput requirement for the data layer abstraction instance 234 such as ten thousand reads per second, then the data abstraction layer controller 202 can determine that a distributed architecture using one or more virtual machines (VMs) can be used to establish an environment that is capable of handling the anticipated workload. Alternatively, if the data layer abstraction instance 234 is designed to handle lighter workloads, then the data abstraction layer controller 202 can determine that a containerized environment can be used. It is noted that the foregoing examples are not meant to be limiting, and that the data abstraction layer controller 202 can implement any number, type, form, etc., of environment(s) effective for executing the data layer abstraction instance 234 in accordance with the set of configuration parameters, consistent with the scope of this disclosure.

Based on the evaluations, the data abstraction layer controller 202 can establish a data abstraction layer engine 232 in accordance with the request. After the data abstraction layer engine 232 is effectively established, the data abstraction layer controller 202 can implement the data abstraction layer instance 234 within the data abstraction layer engine 232. For example, the data abstraction layer controller 202 can load, within the data abstraction layer engine 232, the security logic 206, the data operation logic 208, and other requisite components associated with the data abstraction layer 109. The data abstraction layer controller 202 can then configure the data abstraction layer instance 234 based on the set of configuration parameters included in the request. For instance, if the set of configuration parameters specifies a security requirement such as end-to-end encryption, then the data abstraction layer controller 202 can configure the data layer abstraction instance 234 to utilize acceptable encryption protocols. Similarly, if the request includes access control settings, such as limiting access to specific IP ranges or user roles, then the data abstraction layer controller 202 can apply such restrictions during the initialization of the data layer abstraction instance 234. It is noted that the foregoing examples are not meant to be limiting, and that the data abstraction layer controller 202 can implement any number, type, form, etc., of operation(s) for effectively implementing the data layer abstraction instance 234 within the data abstraction layer engine 232, at any level of granularity, consistent with the scope of this disclosure.

According to some embodiments, the data abstraction layer controller 202, the data layer abstraction instance 234, etc., can configure one or more datastores 110 in accordance with the set of configuration parameters. For example, if the set of configuration parameters indicates a requirement of enhanced I/O operation performance, then one or more datastores 110 can be optimized for the enhanced I/O operation performance by implementing appropriate indexing techniques, caching mechanisms, partitioning strategies, and the like. in another example, if security parameters such as data encryption or restricted access are specified, then the datastores 110 can be configured to enforce appropriate settings, such as enabling server-side encryption, restricting access through role-based permissions, configuring secure connections (e.g., HTTPS or SSH) for data transfers, and the like. Additionally, operational parameters such as data formatting or transformation rules can be implemented at the datastore 110 level to promote seamless compatibility and alignment with the data abstraction layer instance 234.

According to some embodiments, when the data layer abstraction instance 234 is effectively initialized within the data abstraction layer engine 232, the data abstraction layer controller 202 can perform a series of validation checks to determine an operational readiness of the data layer abstraction instance 234. Such checks can include, for example, verifying network connectivity to the datastores 110, testing the execution of sample data operations to confirm adherence to performance benchmarks, auditing security configurations to ensure compliance with the set of configuration parameters, and the like. Any errors or discrepancies identified during this phase can be logged, and corrective actions can be initiated, such as reallocating resources, updating configuration files, reinitializing components, and the like.

According to some embodiments, when the data layer abstraction instance 234 has been established and validated, the data abstraction layer controller 202 can update data abstraction layer configurations 204 to enable the data layer abstraction instance 234 to be reestablished (e.g., automatically in the event of a failure of the data abstraction layer engine 232/data layer abstraction instance 234). According to some embodiments, the data abstraction layer configurations 204 can also be used to enable the data layer abstraction instance 234 to be accessed by the software application 103 (as well as other software applications 103 that are permitted to access the data layer abstraction instance 234). In particular, the routing engine 218 can be updated in accordance with the data abstraction layer configurations 204 to effectively route requests that are directed to the data layer abstraction instance 234 to be routed to the data layer abstraction instance 234.

According to some embodiments, the data gateway 107 can implement mechanisms to ensure that the executions of the data abstraction layer engines 232 and their respective data abstraction layer instances 234 remain isolated and do not interfere with one another (illustrated in FIG. 2 as isolations 250). In particular, the data abstraction layer controller 202 can establish an environment for each data abstraction layer engine 232 that is isolated in terms of resources, process execution, and data access. This can be achieved using virtualization techniques such as containers or virtual machines, where each data abstraction layer engine 232 operates within an isolated runtime environment. For example, containers can be configured with dedicated CPU, memory, and storage allocations to prevent resource contention between data abstraction layer engines 232. Additionally, network namespaces can be employed to ensure that each data abstraction layer engine 232 possesses a respective virtualized network stack, which can help prevent unintended cross-communication between the data abstraction layer engines 232. File system isolation techniques, such as mounting specific directories or volumes for each data abstraction layer engine 232, can also be implemented to ensure that data associated with one data abstraction layer engine 232 is not accessible to other data abstraction layer engines 232. The data abstraction layer controller 202 can also implement security policies to further enforce isolation, such as by restricting inter-process communications and applying access controls to limit permissions. By leveraging these isolation mechanisms, the data gateway 107 can reduce the likelihood that errors, resource bottlenecks, malicious activity, etc., in one data abstraction layer engine 232, data layer abstraction instance 234, etc., does not impact the performance, security, or functionality of other data abstraction layer engines 232, data layer abstraction instances 234, etc. This approach can provide robust scalability and reliability, even in environments with multiple concurrently executing data abstraction layer engines 232 and data layer abstraction instances 234.

Additionally, and according to some embodiments, the data abstraction layer controller 202 can be configured to monitor the data layer abstraction instance 234 during its operation to ensure the data layer abstraction instance 234 operates in accordance with the set of configuration parameters. For example, real-time telemetry data associated with the data layer abstraction instance 234 can be analyzed by the data abstraction layer controller 202 to detect performance bottlenecks, security anomalies, and the like. If necessary, the data abstraction layer controller 202 can dynamically adjust the resources, configurations, etc., of the data abstraction layer engine 232, the data layer abstraction instance 234, etc., to maintain compliance with the operational requirements.

### Data Abstraction Layer Instance Generation

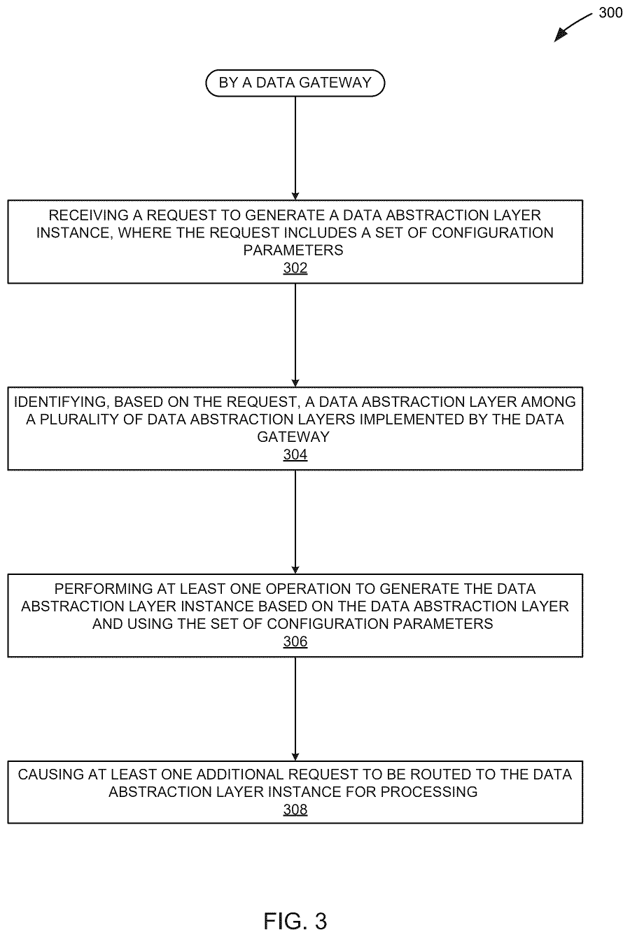

FIG. 3 sets forth a flow diagram of method steps for implementing data abstraction layers via the data gateway 107, according to various embodiments. As shown in FIG. 3, a method 300 begins at step 302, where the data gateway 107 receives a request to generate a data abstraction layer instance, where the request includes a set of configuration parameters (e.g., as described above in conjunction with FIGS. 1-2). At step 304, the data gateway 107 identifies, based on the request, a data abstraction layer among a plurality of data abstraction layers implemented by the data gateway (e.g., as also described above in conjunction with FIGS. 1-2). At step 306, the data gateway 107 performs at least one operation to generate the data abstraction layer instance based on the data abstraction layer and using the set of configuration parameters (e.g., as also described above in conjunction with FIGS. 1-2). At step 308, the data gateway 107 causes at least one additional request to be routed to the data abstraction layer instance for processing (e.g., as further described above in conjunction with FIGS. 1-2).

### Data Abstraction Layer Instance Utilization

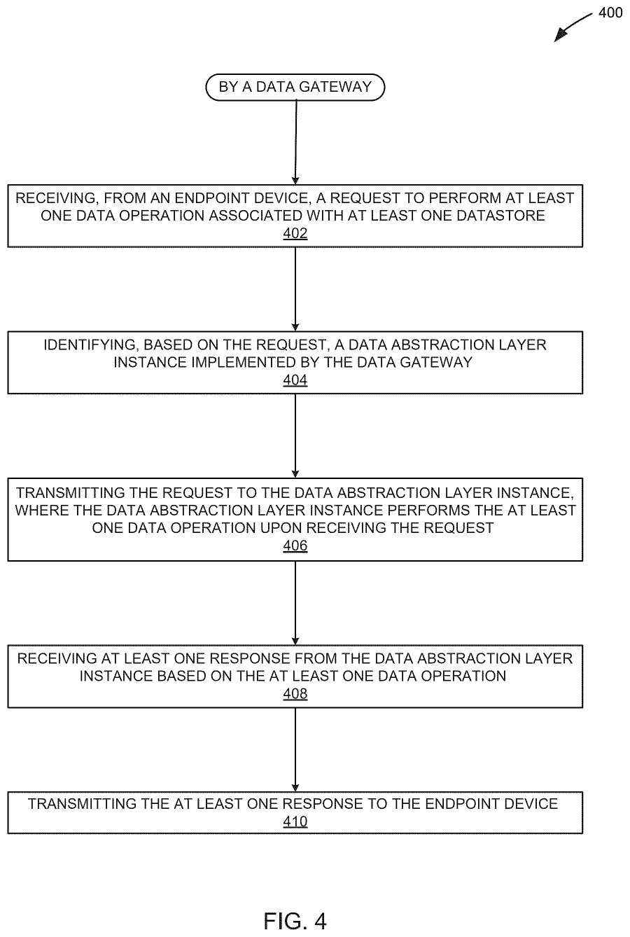

FIG. 4 sets forth a flow diagram of method steps for performing data operations using data abstraction layer instances implemented by the data gateway 107, according to various embodiments. As shown in FIG. 4, a method 400 begins at step 402, where the data gateway 107 receives, from an endpoint device, a request to perform at least one data operation associated with at least one datastore (e.g., as described above in conjunction with FIGS. 1-2). At step 404, the data gateway 107 identifies, based on the request, a data abstraction layer instance implemented by the data gateway (e.g., as also described above in conjunction with FIGS. 1-2). At step 406, the data gateway 107 transmits the request to the data abstraction layer instance, wherein the data abstraction layer instance performs the at least one data operation upon receiving the request (e.g., as also described above in conjunction with FIGS. 1-2). At step 408, the data gateway 107 receives at least one response from the data abstraction layer instance based on the at least one data operation (e.g., as also described above in conjunction with FIGS. 1-2). At step 410, the data gateway 107 transmits the at least one response to the endpoint device (e.g., as further described above in conjunction with FIGS. 1-2).

### Computing Device Overview

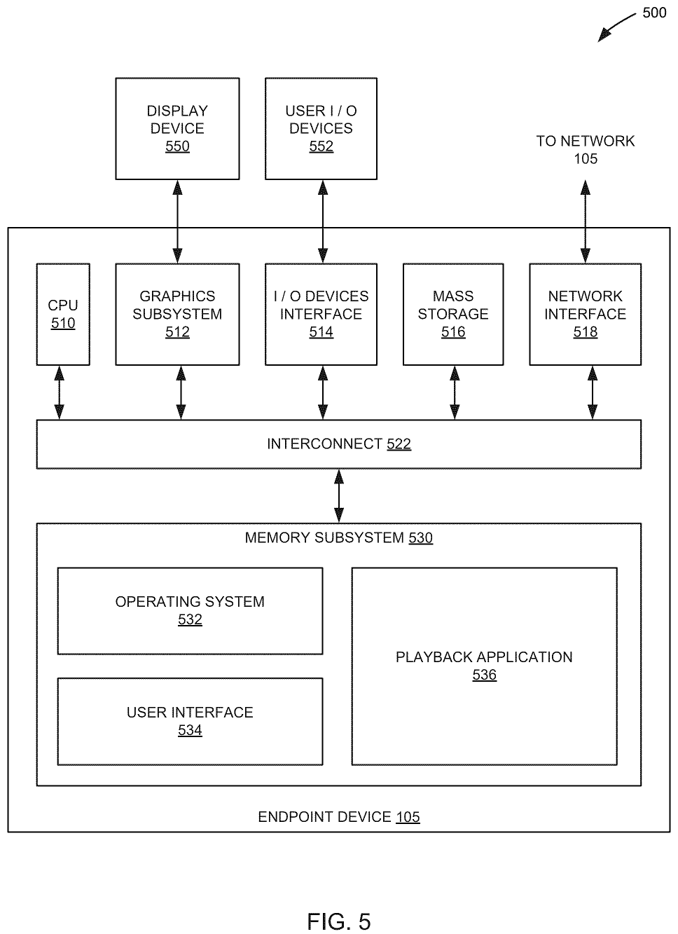

FIG. 5 is a conceptual illustration of a computing device 500 that can be used to implement any of the computing devices shown in FIG. 1, including an endpoint device 102, a server device 106, a developer device 108, and a datastore 110, according to various embodiments. As shown, the computing device 500 can include, without limitation, a CPU 510, a graphics subsystem 512, an I/O device interface 514, a mass storage unit 516, a network interface 518, an interconnect 522, and a memory subsystem 530.

In some embodiments, the CPU 510 is configured to retrieve and execute programming instructions stored in the memory subsystem 530. Similarly, the CPU 510 is configured to store and retrieve application data (e.g., software libraries) residing in the memory subsystem 530. The interconnect 522 is configured to facilitate transmission of data, such as programming instructions and application data, between the CPU 510, graphics subsystem 512, I/O devices interface 514, mass storage 516, network interface 518, and memory subsystem 530.

In some embodiments, the graphics subsystem 512 is configured to generate frames of video data and transmit the frames of video data to display device 550. In some embodiments, the graphics subsystem 512 can be integrated into an integrated circuit, along with the CPU 510. The display device 550 can comprise any technically feasible means for generating an image for display. For example, the display device 550 can be fabricated using liquid crystal display (LCD) technology, cathode-ray technology, and light-emitting diode (LED) display technology. An input/output (I/O) device interface 514 is configured to receive input data from user I/O devices 552 and transmit the input data to the CPU 510 via the interconnect 522. For example, user I/O devices 552 can comprise one of more buttons, a keyboard, and a mouse or other pointing device. The I/O device interface 514 also includes an audio output unit configured to generate an electrical audio output signal. User I/O devices 552 includes a speaker configured to generate an acoustic output in response to the electrical audio output signal. In alternative embodiments, the display device 550 can include the speaker. A television is an example of a device known in the art that can display video frames and generate an acoustic output.

A mass storage unit 516, such as a hard disk drive or flash memory storage drive, is configured to store non-volatile data. A network interface 518 is configured to transmit and receive packets of data via the communications network 104. In some embodiments, the network interface 518 is configured to communicate using the well-known Ethernet standard. The network interface 518 is coupled to the CPU 510 via the interconnect 522.

In some embodiments, the memory subsystem 530 includes programming instructions and application data that comprise an operating system 532, a user interface 534, and a playback application 536. The operating system 532 performs system management functions such as managing hardware devices including the network interface 518, mass storage unit 516, I/O device interface 514, and graphics subsystem 512. The operating system 532 also provides process and memory management models for the user interface 534 and the playback application 536. The user interface 534, such as a window and object metaphor, provides a mechanism for user interactions. Persons skilled in the art will recognize the various operating systems and user interfaces that are well-known in the art and suitable for incorporation into the various devices of FIG. 1.

It will be appreciated that the endpoint device 102, server device 106, developer device 108, and datastore 110 described above in conjunction with FIGS. 1-4 are illustrative, and that variations and modifications are possible. The connection topologies, including the number of CPUs and memories, may be modified as desired, and, in certain embodiments, one or more components shown in FIGS. 1-5 may not be present. Further, in certain embodiments, one or more components shown in FIGS. 1-5 may be implemented as virtualized resources in a virtual computing environment and/or a cloud computing environment.

In sum, the disclosed techniques set forth a comprehensive system for a data gateway that facilitates interactions between software applications, datastores, and datasets by implementing data abstraction layers. Developers can issue requests to the data gateway to register new data abstraction layers with the data gateway. In turn, an a software application executing on an endpoint device can submit a request to the data gateway to generate a data layer abstraction instance of a particular data abstraction layer. The request can include configuration parameters that specify how the data layer abstraction instance should be tailored to meet the operational needs of the software application. In response to the request, the data gateway implements a data abstraction layer engine to function as an execution environment for the data layer abstraction instance. The data gateway then configures the data abstraction layer engine, the data layer abstraction instance, etc., based on the provided configuration parameters so that the data layer abstraction instance is optimized for the intended data operations to be performed by the data layer abstraction instance. When the data abstraction layer instance is active, the software application can issue function calls to the data layer abstraction instance. In this regard, the function calls can be routed through the data gateway to allow the software application to access specific data operations without needing to directly interact with the underlying datastores and datasets. The data abstraction layer instance processes the function calls, performs the requested operations on the relevant datastores and datasets, and generates response information reflecting the results of the operations. The response information can then be returned to the software application via the data gateway, thereby enabling seamless communication and integration between the software application, the datastores, and the datasets.

One technical advantage of the disclosed techniques relative to the prior art is that the disclosed techniques enable data operations between different software applications and different datastores to be abstracted, which reduces the need for the software applications to include bespoke code for interacting with different types of datastores. As a result, the disclosed techniques can decrease the fragmentation of tooling ecosystems and simplify the integration of additional datastore types within an organization. Additionally, the ability to modify a given data abstraction layer without having to expose changes to the software applications promotes overall scalability. This adaptability allows an organization to efficiently respond to changing operational needs without having to modify or overhaul existing software application codebases. Additionally, the disclosed techniques enable multiple independent instances of a given data abstraction layer to be implemented, which can promote the isolation and autonomy of data operations across different software applications. This capability enhances fault tolerance as data operations performed by one software application do not interfere with data operations performed by other software applications. Moreover, the data abstraction layers can incorporate security logic for implementing various security measures, such as enhanced access control and encryption, which enhances overall data security when accessing data from a given datastore or transmitting data across different datastores.

1. In some embodiments, a computer-implemented method for implementing data abstraction layers via a data gateway comprises receiving a request to generate a data abstraction layer instance, wherein the request includes a set of configuration parameters; identifying, based on the request, a data abstraction layer among a plurality of data abstraction layers implemented by the data gateway; performing at least one operation to generate the data abstraction layer instance based on the data abstraction layer and using the set of configuration parameters; and causing at least one additional request to be routed to the data abstraction layer instance for processing.

2. The computer-implemented method of clause 1, wherein the data abstraction layer instance includes security logic derived from the data abstraction layer, and performing the at least one operation comprises causing the data abstraction layer instance to perform an authentication with at least one datastore associated with the data abstraction layer instance.

3. The computer-implemented method of clause 2, wherein performing the at least one operation further comprises validating at least one authentication credential included in the request.

4. The computer-implemented method of clause 1, wherein the data abstraction layer instance includes data operation logic derived from the data abstraction layer.

5. The computer-implemented method of clause 4, wherein the at least one operation comprises generating an instance of at least one datastore associated with the data operation logic.

6. The computer-implemented method of clause 1, wherein the request is transmitted by an endpoint device, and the method further comprises authenticating at least one of the endpoint device or a user associated with the endpoint device prior to performing the at least one operation.

7. The computer-implemented method of clause 1, wherein the data abstraction layer instance is included in a plurality of data abstraction layer instances implemented by the data gateway, and each data abstraction layer instance included in the plurality of data abstraction layer instances is associated with a particular data abstraction layer included in the plurality of data abstraction layers.

8. The computer-implemented method of clause 7, wherein first data operations executed by the data abstraction layer instance are isolated from second data operations executed by a different data abstraction layer instance included in the plurality of data abstraction layer instances.

9. The computer-implemented method of clause 1, further comprising performing at least one second operation to generate a second data abstraction layer instance based on a second data abstraction layer included in the plurality of data abstraction layers and using a second set of configuration parameters.

10. The computer-implemented method of clause 1, wherein the set of configuration parameters includes at least one of a read operation capacity, a write operation capacity, a latency capacity, a retention scheme, or a service criticality level.

11. In some embodiments, one or more non-transitory computer readable media store instructions that, when executed by one or more processors, cause the one or more processors to implement data abstraction layers via a data gateway, by performing the steps of receiving a request to generate a data abstraction layer instance, wherein the request includes a set of configuration parameters; identifying, based on the request, a data abstraction layer among a plurality of data abstraction layers implemented by the data gateway; performing at least one operation to generate the data abstraction layer instance based on the data abstraction layer and using the set of configuration parameters; and causing at least one additional request to be routed to the data abstraction layer instance for processing.

12. The one or more non-transitory computer readable media of clause 11, wherein the data abstraction layer instance implements at least one function that endpoint devices authorized to interface with the data abstraction layer instance call.

13. The one or more non-transitory computer readable media of clause 12, wherein calling the at least one function comprises receiving at least one function parameter associated with the at least one function.

14. The one or more non-transitory computer readable media of clause 12, wherein the at least function comprises at least one of a data read operation, a data modification operation, or a data migration operation.

15. The one or more non-transitory computer readable media of clause 11, wherein the data abstraction layer instance includes security logic derived from the data abstraction layer, and performing the at least one operation comprises causing the data abstraction layer instance to perform an authentication with at least one datastore associated with the data abstraction layer instance.

16. The one or more non-transitory computer readable media of clause 15, wherein performing the at least one operation further comprises validating at least one authentication credential included in the request.

17. The one or more non-transitory computer readable media of clause 11, wherein the data abstraction layer instance includes data operation logic derived from the data abstraction layer.

18. The one or more non-transitory computer readable media of clause 17, wherein the at least one operation comprises generating an instance of at least one datastore associated with the data operation logic.

19. The one or more non-transitory computer readable media of clause 11, wherein the request is transmitted by an endpoint device, and the steps further comprise authenticating at least one of the endpoint device or a user associated with the endpoint device prior to performing the at least one operation.

20. In some embodiments, a computer system comprises one or more memories that include instructions, and one or more processors that are coupled to the one or more memories and that, when executing the instructions, are configured to implement data abstraction layers via a data gateway, by performing the operations of: receiving a request to generate a data abstraction layer instance, wherein the request includes a set of configuration parameters; identifying, based on the request, a data abstraction layer among a plurality of data abstraction layers implemented by the data gateway; performing at least one operation to generate the data abstraction layer instance based on the data abstraction layer and using the set of configuration parameters; and causing at least one additional request to be routed to the data abstraction layer instance for processing.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for implementing data abstraction layers via a data gateway, the method comprising:
receiving a request to generate a data abstraction layer instance, wherein the request includes a set of configuration parameters;
identifying, based on the request, a data abstraction layer among a plurality of data abstraction layers implemented by the data gateway;
performing at least one operation to generate the data abstraction layer instance based on the data abstraction layer and using the set of configuration parameters; and
causing at least one additional request to be routed to the data abstraction layer instance for processing.

2. The computer-implemented method of claim 1, wherein the data abstraction layer instance includes security logic derived from the data abstraction layer, and performing the at least one operation comprises causing the data abstraction layer instance to perform an authentication with at least one datastore associated with the data abstraction layer instance.

3. The computer-implemented method of claim 2, wherein performing the at least one operation further comprises validating at least one authentication credential included in the request.

4. The computer-implemented method of claim 1, wherein the data abstraction layer instance includes data operation logic derived from the data abstraction layer.

5. The computer-implemented method of claim 4, wherein the at least one operation comprises generating an instance of at least one datastore associated with the data operation logic.

6. The computer-implemented method of claim 1, wherein the request is transmitted by an endpoint device, and further comprising authenticating at least one of the endpoint device or a user associated with the endpoint device prior to performing the at least one operation.

7. The computer-implemented method of claim 1, wherein the data abstraction layer instance is included in a plurality of data abstraction layer instances implemented by the data gateway, and each data abstraction layer instance included in the plurality of data abstraction layer instances is associated with a particular data abstraction layer included in the plurality of data abstraction layers.

8. The computer-implemented method of claim 7, wherein first data operations executed by the data abstraction layer instance are isolated from second data operations executed by a different data abstraction layer instance included in the plurality of data abstraction layer instances.

9. The computer-implemented method of claim 1, further comprising performing at least one second operation to generate a second data abstraction layer instance based on a second data abstraction layer included in the plurality of data abstraction layers and using a second set of configuration parameters.

10. The computer-implemented method of claim 1, wherein the set of configuration parameters includes at least one of a read operation capacity, a write operation capacity, a latency capacity, a retention scheme, or a service criticality level.

11. One or more non-transitory computer readable media storing instructions that, when executed by one or more processors, cause the one or more processors to implement data abstraction layers via a data gateway, by performing the steps of:
receiving a request to generate a data abstraction layer instance, wherein the request includes a set of configuration parameters;
identifying, based on the request, a data abstraction layer among a plurality of data abstraction layers implemented by the data gateway;
performing at least one operation to generate the data abstraction layer instance based on the data abstraction layer and using the set of configuration parameters; and
causing at least one additional request to be routed to the data abstraction layer instance for processing.

12. The one or more non-transitory computer readable media of claim 11, wherein the data abstraction layer instance implements at least one function that endpoint devices authorized to interface with the data abstraction layer instance call.

13. The one or more non-transitory computer readable media of claim 12, wherein calling the at least one function comprises receiving at least one function parameter associated with the at least one function.

14. The one or more non-transitory computer readable media of claim 12, wherein the at least function comprises at least one of a data read operation, a data modification operation, or a data migration operation.

15. The one or more non-transitory computer readable media of claim 11, wherein the data abstraction layer instance includes security logic derived from the data abstraction layer, and performing the at least one operation comprises causing the data abstraction layer instance to perform an authentication with at least one datastore associated with the data abstraction layer instance.

16. The one or more non-transitory computer readable media of claim 15, wherein performing the at least one operation further comprises validating at least one authentication credential included in the request.

17. The one or more non-transitory computer readable media of claim 11, wherein the data abstraction layer instance includes data operation logic derived from the data abstraction layer.

18. The one or more non-transitory computer readable media of claim 17, wherein the at least one operation comprises generating an instance of at least one datastore associated with the data operation logic.

19. The one or more non-transitory computer readable media of claim 11, wherein the request is transmitted by an endpoint device, and the steps further comprise authenticating at least one of the endpoint device or a user associated with the endpoint device prior to performing the at least one operation.

20. A computer system, comprising:
one or more memories that include instructions; and
one or more processors that are coupled to the one or more memories and, when executing the instructions, are configured to implement data abstraction layers via a data gateway, by performing the operations of:
receiving a request to generate a data abstraction layer instance, wherein the request includes a set of configuration parameters;
identifying, based on the request, a data abstraction layer among a plurality of data abstraction layers implemented by the data gateway;
performing at least one operation to generate the data abstraction layer instance based on the data abstraction layer and using the set of configuration parameters; and
causing at least one additional request to be routed to the data abstraction layer instance for processing.
